(19) United States
(12) Patent Application Publication
(10) Pub. No.: US 2020/0242518 A1
(43) Pub. Date: Jul. 30, 2020

(54) ALLOCATION SYSTEM FOR SUBORDINATE

(71) Applicant: Kazuto NAKAMURA, Osaka (JP)

(72) Inventor: Kazuto NAKAMURA, Osaka (JP)

(21) Appl. No.: 16/674,677

(22) Filed: Nov. 5, 2019

(30) Foreign Application Priority Data
Jan. 25, 2019 (JP) 2019-011238

(51) Int. Cl. G06Q 10/02; H04L 29/06

(52) U.S. Cl. CPC G06Q 10/02; H04L 63/0853

(57) ABSTRACT

An allocation system for dispatching a vehicle based on a request from a client, comprising: a master phone owned by a master as a client, a subordinate phone owned by a dependent, a management server for processing the dispatch, and a driver phone owned by a driver, wherein the management server registers a personal account of the master, a master account, and a subordinate account, wherein the master account and the subordinate account are registered with indexed. The management server receives the dispatch request sent from the master phone, informs the vehicle selection information to the master phone, informs the dispatch request to the driver phone, informs the vehicle information to the master phone and subordinate phone, and receives a boarding completion notice send from the subordinate phone, after pick-up vehicle arriving to the pick-up place and the subordinate boarding on the vehicle.

This application claims the benefit of priority to Japanese Patent Application No. 2019-011238 filed on Jan. 25, 2019, the content of which is incorporated herein by reference.

### BACKGROUND OF THE INVENTION

The present invention relates to an allocation system for dispatching a business vehicle to a designate place based on a request from a client for subordinate.

In existing an allocation system using an application for a dispatch request, when a client requests a dispatch of a taxi vehicle or a ride share vehicle (business vehicle of which a charge meter is not mounted and fare is decided based on a distance using an application), the client must wait at a designate pick-up place until a business vehicle comes. Namely, in existing an allocation system, a client cannot request dispatch a business vehicle for distant existing client's family (ex. old man or children) instead of the client's family

In detail, in existing an allocation system (see, for example, Japanese Laid open 2017-204042), a personal account information having an authority as a user is only register in an application for a dispatch request. Then, a client who is register as a personal account cannot input another person's information whom he wants to boarding instead of himself.

### SUMMARY OF THE INVENTION

For that reason, when a client using an application requests a dispatch business vehicle, he must wait a vehicle coming at a dispatch request place together with a passenger, and boarding together. Then, even if the client is registered as a user of an application of allocation system, he cannot request a dispatch vehicle for a people (ex. family, elderly or children) who are existing at a distant place or difficult to use the application.

Further, even a user of the application requests dispatch vehicle waiting together with such a person at a pick-up place, if the vehicle leaves the pick-up place, he can only watch over to confirm that the vehicle arrives to a destination. Then, he worries about whether his family (old man or children) is riding safely without being at risk.

The present invention is to solve the above problem, and provides an allocation system which a client can request dispatch vehicle for subordinate (family or dependent) such as an old man or children who are away from the clients. Further, if necessary, the allocation system offers a client can check a video in the vehicle by a client's terminal and the client can report an emergency to an emergency organization when an abnormality occurs inside the car.

The allocation system of the present invention is for dispatching a vehicle based on a request from a client, comprising:

a master phone owned by a master who are a client for receiving a dispatch service,

a subordinate phone owned by a dependent who is depend on the master,

a management server for processing the dispatch based on an application for executing the dispatch service according to the dispatch request from the client, and

a driver phone owned by a driver who move a vehicle to a pick-up place according to an instruction sent from the management server,

wherein

the master phone, the subordinate phone, the management server, and the driver phone are connectable to the internet,

the management server registers a personal account of the master, a master account capable of exercises master's authority, and a subordinate account depend on the master account, in accordance with a transmission from the master phone downloaded the application, wherein the master account and the subordinate account are registered with indexed,

the management server:

receives the dispatch request sent from the master phone to go a pick-up place for picking-up the subordinate,

choices adequate vehicle for the picking-up,

informs the vehicle selection information to the master phone,

receives a consent from the master phone,

informs the dispatch request to the driver phone, and then

receives a pick-up consent from the driver phone, further continuously

informs the vehicle information to the master phone and subordinate phone, and

receives a boarding completion notice send from the subordinate phone, after pick-up vehicle arriving to the pick-up place and the subordinate boarding on the vehicle.

Also, the allocation system of the present invention is for dispatching a vehicle based on a request from a client, comprising:

a master phone owned by a master who are a client for receiving a dispatch service,

a phone owned by a dependent who is depend on the master,

a management server for processing the dispatch based on an application for executing the dispatch service according to the dispatch request from the client, and

a driver phone owned by a driver who move a vehicle to a pick-up place according to an instruction sent from the management server,

wherein

the master phone, the management server, and the driver phone are connectable to the internet,

the management server registers a personal account of the master, a master account capable of exercises master's authority, and a subordinate's information, in accordance with a transmission from the master phone downloaded the application, wherein the master account and the subordinate's information are registered with indexed,

the management server sets a password for the subordinate's information,

the management server:

receives the dispatch request sent from the master phone to go a pick-up place for picking-up the subordinate,

choices adequate vehicle for the picking-up,

informs the vehicle selection information to the master phone,

receives a consent from the master phone,

informs the dispatch request to the driver phone, and then

receives a pick-up consent from the driver phone, further continuously

informs the vehicle information to the master phone, and sends the password to the master phone, and

receives a boarding completion notice and the password send from the driver phone, after pick-up vehicle arrives to the pick-up place and the subordinate boards on the vehicle, under conditions that the subordinate is informed of the dispatch request and the password by phone call from the master.

According to the present invention, since a master account and a subordinate account or password information are registered with indexed in an application, the master as a client can request a dispatch vehicle for a subordinate who are staying at a distant place.

### BRIEF DESCRIPTION OF THE DRAWINGS

FIG. 1 is overall structure view showing an embodiment of allocation system according to the present invention.

FIG. 2 is a view showing an Account input screen of a master phone in the allocation system.

FIG. 3 is a view showing an Account input screen of a subordinate phone owned by a subordinate in the allocation system.

FIG. 4 is a view showing a Vehicle request screen of the master phone.

FIG. 5 is a view showing a vehicle decision screen of the master phone.

FIG. 6 is a view showing a vehicle credit information screen of the master phone.

FIG. 7 is a view showing a Pick-up notice screen of a driver phone in the allocation system.

FIG. 8 is a view showing a Pick-up screen of the driver phone.

FIG. 9 is a view showing a Driver confirmed screen of the master phone.

FIG. 10 is a view showing a Driver confirmed screen of the subordinate phone.

FIG. 11 is a view showing a Boarding security screen of the subordinate phone.

FIG. 12 is a view showing a Boarding security screen of the master phone.

FIG. 13 is a view showing a Charge settlement screen of the driver phone.

FIG. 14 is a time chart showing an operating procedure according to the first embodiment of the allocation system.

FIG. 15 is a time chart showing an operating procedure according to the second embodiment of the allocation system.

### DETAILED DESCRIPTION OF THE INVENTION

### First Embodiment

An allocation system for subordinate in accordance with a first embodiment of the present invention is described with reference to FIGS. The allocation system is for dispatching a vehicle so that a client can request dispatch business vehicle on behalf of subordinate (family or dependent) such as an old man or children who actually board on the vehicle.

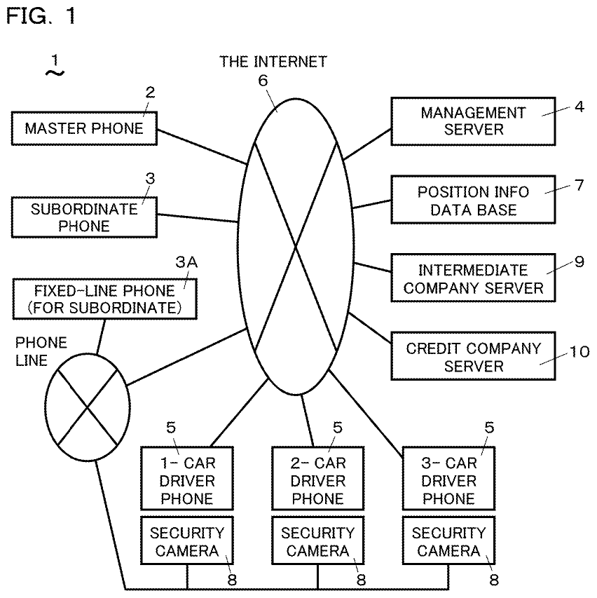

FIG. 1 is an overall structure showing the allocation system of the embodiment. The allocation system 1 comprising:

a master phone 2 owned by a master who are a client for receiving a dispatch service,

a subordinate phone 3 owned by a dependent (parent or children) who is depend on the master,

a management server 4 for processing the dispatch based on an application for executing the dispatch service according to the dispatch request from the client, and

a driver phone 5 owned by a driver who move a vehicle to a pick-up place according to an instruction sent from the management server 4.

The master phone 2 is such as a smartphone connectable to a network (for example internet 6) and able to download an application and use GPS function by a satellite.

The master registers various types account (details below) which grants an authority for use the dispatch application to the management server 4 by using the master phone 2 downloaded the application.

The subordinate phone 3 of the embodiment is such as a smartphone as like of the master phone 2. The master phone 2 and the subordinate phone 3 are existing plural. The master phone 2 and the subordinate phone 3 are download in advance the application for receiving the service dispatch.

The management server 4 is belong to a business unit for offer business service of the allocation system 1 to clients via internet 6.

The management server 4 registers a personal account of the master, a master account capable of exercises master's authority and a subordinate account depend on the master in accordance with a transmission from the master phone 2 downloaded the application, wherein the master account and the subordinate account are registered with indexed.

The management server 4 receives a dispatch request sent from the master phone 2 to go a pick-up place for picking-up the subordinate,

choices adequate vehicle for the picking-up,

informs the vehicle selection information to the master phone 2, and

receives a consent from the master phone 2, then after,

informs the consent to the driver phone 5.
After received the driver's consent of pick-up from the driver phone 5, further continuously, the management server 4 informs the pick-up vehicle information to the master phone 2 and subordinate phone 3.

The pick-up vehicle arrives the pick-up place, and the subordinate is boarding on the vehicle, then after, the management server 4 receives a boarding completion notice send from the subordinate phone 3.

The management server 4 execute the dispatch application by using a position information date base 7 which registers the client information and the position information of the driver phone 5. The management server 4 may have such function.

The driver phone 5 is such as a tablet having a GPS function and connectable to the internet 6, in advance download dispatch application for offer the service. The driver phone 5 is possessed by a driver who boards on a business vehicle. In FIG. 1, 1-Car, 2-Car, and 3-Car are shown as a vehicle. In each vehicle, security camera 8 for automotive is mounted. The security camera 8 images a video (moving image and/or voice) inside the car and send the video to the management server 4 via Sim (Subscriber Identity Module card) Line function.

The system 1 comprises, if necessary, a credit card payment intermediate company server 9 and various credit company server 10 for capable of a credit card payment of service charge. In case of settlement is by cash not by the credit card, it is no need to provide the above. Method of settlement whether the credit card payment or cash may be displayed on a screen of the master phone 2 or the driver phone 5. The master phone 2 or the subordinate phone 3 can report an emergency to an emergency organ (not shown) when emergency occurs inside the car.

### Plural Account Register

The client who want to receive the service registers the following accounts to the management server 4. As for account register, (1) a normal personal account of the master for a personal use dispatch application, (2) a master account capable of exercises master's authority, and (3) a subordinate account depend on the master account: account for a master requests dispatch a vehicle for boarding distant existing client's family (ex. old man or children) instead of the client's family, and account for a master grants authority for fare settlement. The subordinate account may be registered for a plural person.

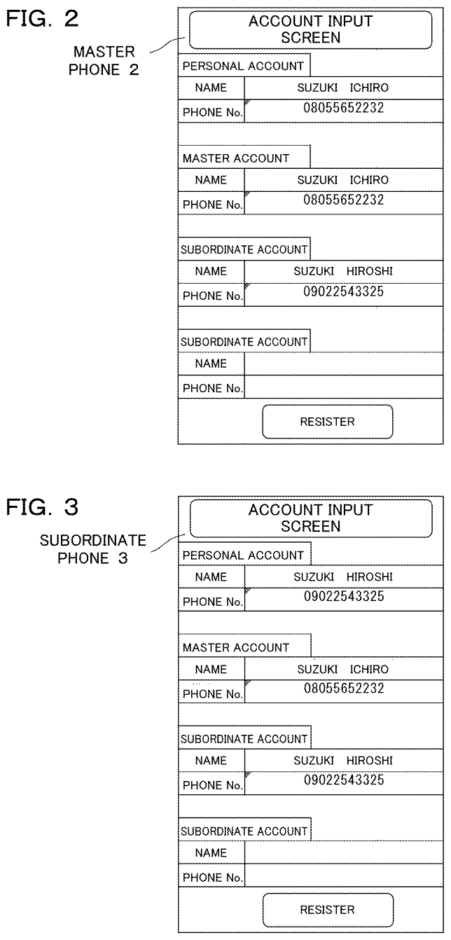

FIG. 2 and FIG. 3 shows Account input screen of the master phone 2 and the subordinate phone 3. The input can be carried by the master phone 2 and the subordinate phone 3 download the dispatch application. Master who want to an authority registers account information (himself full name, phone number etc.) to a personal account input field of the master phone 2.

Master again register to input himself information to a master account input field in case of being subordinate, and register to input subordinate information (subordinate full name, subordinate phone number) to a subordinate account input field. In FIG. 1, 2, an example of inputting a plurality of subordinate information A, B is shown.

Subordinate registers to input an account information (himself full name, phone number etc.) to a personal account input field by the subordinate phone 3. Also, the subordinate registers to input master information (master full name, master phone number etc.) to a master account input field, and registers to input again himself account information to a subordinate account input field.

When various account register is completed, the management server 4 sends a notice that a master account register and a subordinate account register are completed and 4 digits numeral (for example) confirmation cypher number, to each phone by a short mail.

Then after the master and the subordinate, by using the master phone 2 and the subordinate phone 3 downloaded dispatch application, input 4 digits numeral for cypher number confirmation to a input field and send to the management server 4. Thereafter, if the 4 digits numeral is appropriate, dispatch application of the master phone 2 and dispatch application of the subordinate phone 3 are registered with index at the management server 4. Thus, registration of dispatch application downloaded to the master phone 2 and the subordinate phone 3 are completed with index for authority exercise.

### Terminal Screen Transition

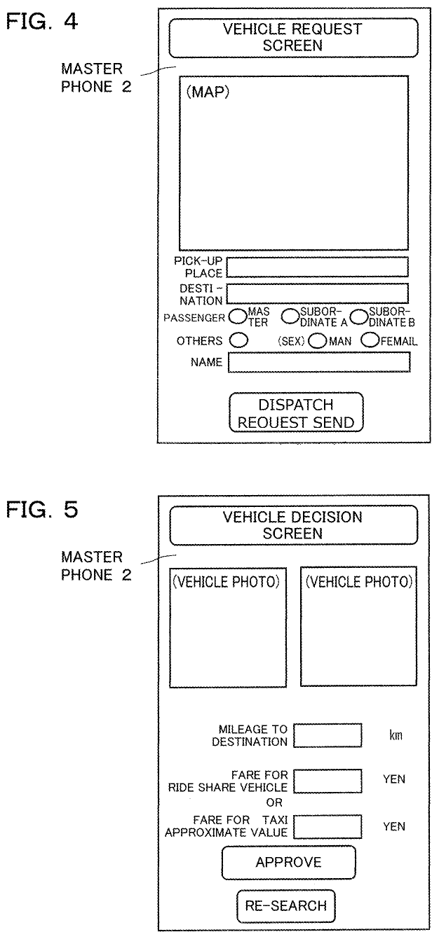

FIG. 4 to FIG. 13 are screen transition of each phone showing that the master requests dispatch vehicle by the master phone 2 to the subordinate owns the subordinate phone 3 with index in the first embodiment.

Master uses the master phone 2 to start the dispatch application, and inputs date on a Vehicle request screen (FIG. 4). Input date is a pick-up place, destination, passenger information. Operating a Dispatch request send button, dispatch request is sent to the management server 4. The management server 4 choices appropriate vehicle and sends a notice of a driver information to the dispatch application of the master phone 2. The driver information is displayed on a vehicle decision screen of the master phone 2 (refer to FIG. 5).

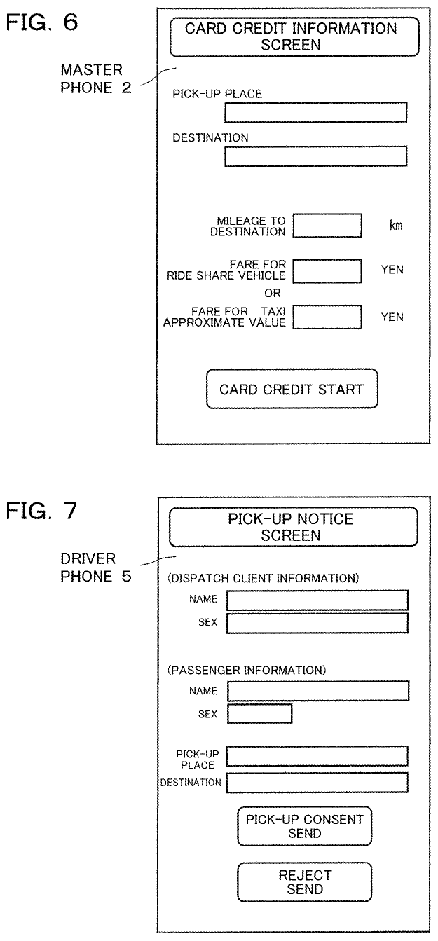

The master confirms the driver information noticed to the master phone 2 and judges whether to approve or not the driver, and then notes a judgment result to the management server 4. In case of non-approval, the master taps a Re-search button, thereby a re-search command is sent to the management server 4. Then the management server 4 re-searches the driver and notices again changed driver information to the master phone 2. Then the master judges again whether to approve or not the changed driver. When the master approves the driver, he sends an approval to the management server 4. Then the master phone 2 notices a card credit information screen (FIG. 6) to the dispatch application of the master phone 2.

The master sees the card credit information screen and taps a Card credit start button on the screen for get start the credit review. The credit amount of money is listed on the screen for a ride share vehicle, and approximate amount is listed on the screen for a taxi vehicle. Either of the credit amount of money is credited. For a credit of the ride share vehicle, fare depending on a distance is confirmed beforehand, so the credit and approval (consent) are done at the same time.

In accordance with the above card credit processing, the management server 4 sends a credit for a card payment to the credit company server 10 via the intermediate company server 9, and is noticed the result from the credit company server 10. When approved, the management server 4 notifies that there was a pick-up request to the driver phone 5 downloaded the dispatch application. Then, a Pick-up notice screen (FIG. 7) is displayed on the driver phone 5. Contents of notice are the master (namely dispatch client) information, a subordinate (namely boarding person's) information, a pick-up place, and a destination. Although not shown in FIG. 7, a settlement method and fare (in case of taxi, approximate amount) may be included in the notice.

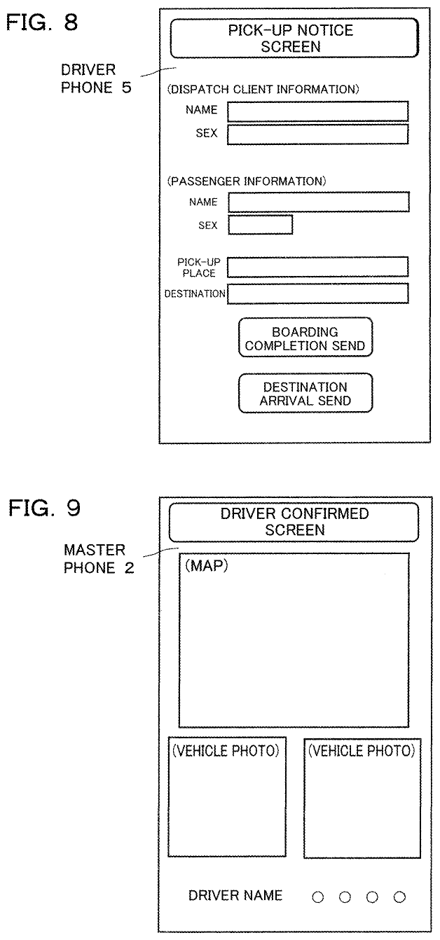

The driver owns the driver phone 5 confirms the information and choices to accept or reject the pick-up request. When accepting, the driver taps a Pick-up consent send button on a screen of the driver phone 5, when refusing, the driver taps a Reject send button thereof (refer to FIG. 7). In case of accepting, a Pick-up screen (refer to FIG. 8) is displayed on the driver phone 5. In case of refusing, the management server 4 again performs a process of selecting a vehicle.

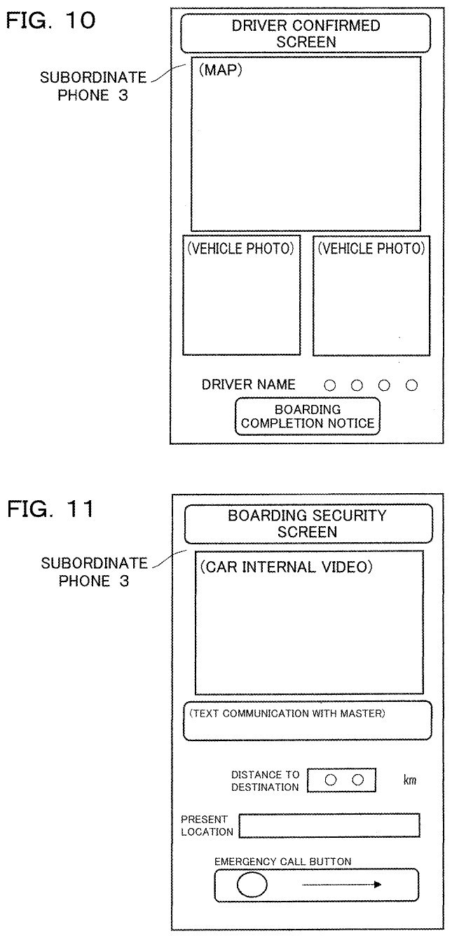

When the driver sent a pick-up consent, the management server 4 notices a Driver confirmed screen (FIG. 9) to a dispatch application of the master phone 2 and a Driver confirmed screen (FIG. 10) to a dispatch application of the subordinate phone 3.

After the vehicle arrives at the pick-up place, the driver confirms a boarding subordinate, and also the subordinate confirms the vehicle. If there is no mistake, the subordinate boards on the vehicle.

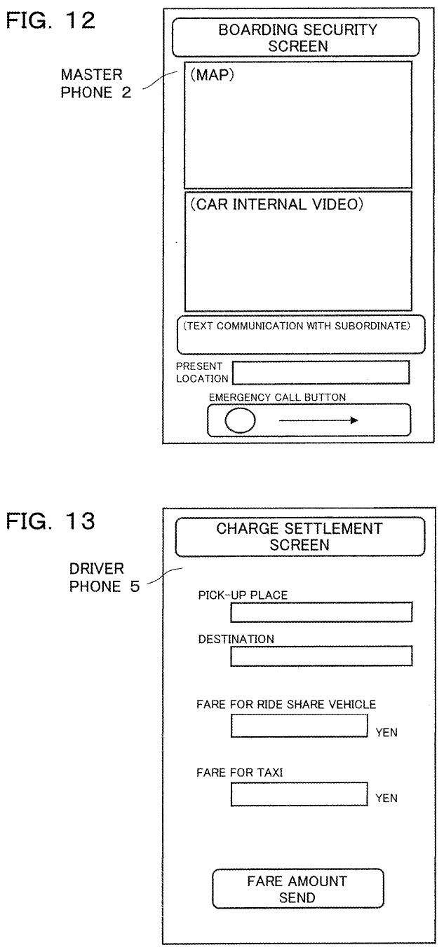

Thereafter, the driver taps a boarding complete send button in the Pick-up screen (FIG. 8) of the driver phone 5 thereby notices the subordinate boarding to the management server 4. Also, the subordinate taps a Boarding completion notice button on the Driver confirmed screen (FIG. 10) of the subordinate phone 3 thereby notices the Boarding completion to the management server 4. By notifying the boarding, the management server 4 notices a Boarding security screen (FIG. 11) to the dispatch application of the subordinate phone 3, and also notices a Boarding security screen (FIG. 12) to the dispatch application of the master phone 2. Starting method of the security camera 8 for getting a car internal video will be described later.

The master (owns the master phone 2) watching the boarding subordinate as well as the boarding subordinate (owns the subordinate phone 3) can report an emergency to an emergency organization when the emergency happens inside the vehicle where the subordinate is boarding, instead of the subordinate. The notification is made by sliding the Emergency call button in the direction of the arrow.

When the vehicle arrives to a destination, the driver makes a credit card payment by a Charge settlement screen (FIG. 13) on driver phone 5. In case of a dispatch of ride share vehicle, since a fare based on a distance is confirmed at a time of credit consent, final consent is completed. In boarding on taxi vehicle, the driver entries charge amount by a taxi meter on the Fare column in the Charge settlement screen (FIG. 13) of the dispatch application of the driver phone 5. Tapping a Fare amount send button on the Charge settlement screen, credit card payment is finished.

### Operating Procedure in the System of the First Embodiment

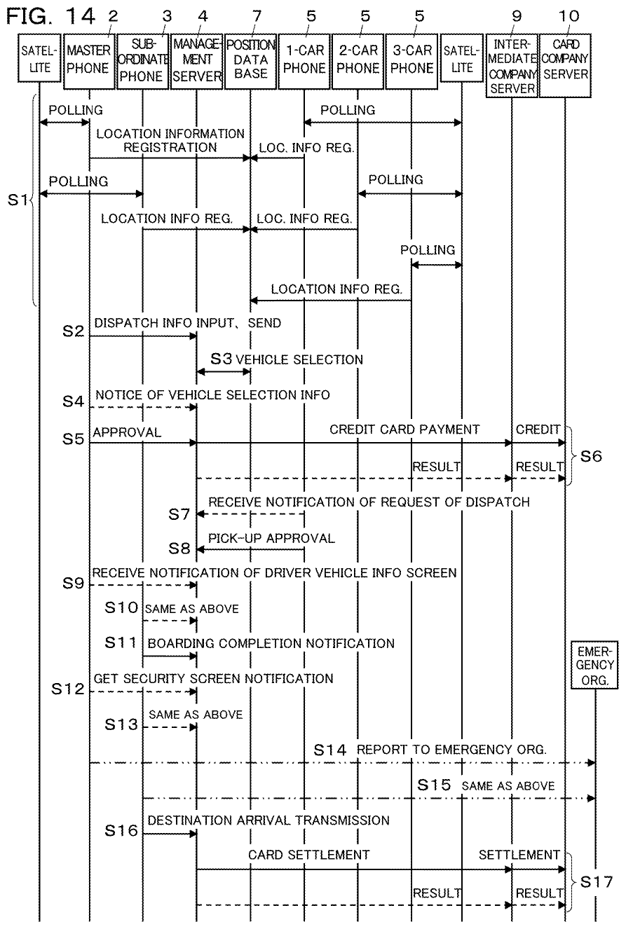

FIG. 14 is a time chart showing an operating procedure of the allocation system according to the first embodiment. This shows operating procedure in time series (top to bottom) among the master phone 2, the subordinate phone 3, the management server 4, the driver phone 5 (1-3 Cars), and the other server etc. The master phone 2, the subordinate phone 3 and the driver phone 5 start the dispatch application, to get a position information by a polling GPS information and register it on a position information date base 7 (S1).

Next, the master inputs a dispatch request information on the master phone 2, and sends it to the management server 4 (S2). The management server 4 refers a position information registered on the position information date base 7, thereby choices an appropriate vehicle (S3). By accessing the management server 4 from the master phone 2, the master phone 2 receives a notice of a vehicle selection information (S4). If the master accepts it, he notices of a consent to the management server 4 (S5). In case of a credit card payment, the management server 4 credits a card payment to the intermediate company server 9 and the card company server 10, then the management server 4 receives a settlement result (S6).

By accessing the management server 4 from the driver phone 5, the driver phone 5 receives a notice of a dispatch request (S7). The driver is if convenient sends a pick-up consent to the management server 4 (S8). After being the pick-up consent, by accessing the management server 4 from the master phone 2, the master phone 2 receives a notice of the Driver confirmed screen (FIG. 9) (S9). The notice includes the driver and vehicle information. Also, by accessing management server 4 from the subordinate phone 3, the subordinate phone 3 receives a notice of the Driver confirmed screen (FIG. 10) (S10). The notice includes the driver and vehicle information.

Then after, a vehicle arrives to a pick-up place and the subordinate boards on the vehicle, a Boarding completion notice is sent from the subordinate phone 3 (S11). By accessing the management server 4 from the master phone 2 and the subordinate phone 3, receives a notice of the Boarding security screen (FIG. 11, 12) (S12, S13). Then an internal video can browse by the master phone 2 and the subordinate phone 3. While the master and the subordinate browse the Boarding security screen, when an abnormal situation occurs, the master and the subordinate can report it to the emergency organization from the master phone 2 and the subordinate phone 3 (S14, S15). After the vehicle arrived to the destination, the subordinate sends a destination arrival to the management server 4 from the subordinate phone 3 (S16). Then in case of a credit card payment, the management server 4 credits to the intermediate company server 9 and the card company server 10 and receives a settlement result (S17).

Above mentioned various processing (S4, S7, S9, S10, S12, S13 etc. shown with dashed line on time chart) as such the master phone 2 etc. receives a notice of an information, can be done by browsing the management server 4 from the master phone 2 etc. They are included within the scope of the claims described that the management server 4 informs any information to the master phone 2 etc. And, in case that a settlement method for payment is not credit card, but is prepaid card, the processing of S6 and S17 can be omitted.

### Second Embodiment

Explained is an allocation system according to the second embodiment of the present invention. The allocation system of the embodiment is in case of the subordinate owns a phone 3A (such as a Fixed-line phone) (FIG. 1) which is not connectable to the internet. Such a phone is not indexed to the master phone 2. For such subordinate, the master can request dispatch vehicle from the master phone 2. In the second embodiment, instead of indexed of master account and subordinate account, one-time password for example is used for index. Thereby, the master can offer a dispatch vehicle and pay fare by using the master phone 2 for such a subordinate who do not own a phone connectable to the internet.

In the system of the second embodiment, the phone 3A which is not connectable to the internet is used instead of the subordinate phone 3 in FIG. 1. Following is a different point from the first embodiment as for an operating procedure of the system. The management server 4 issues a password for index the subordinate, and notices the password to the master phone 2.

When the master requests dispatch instead of the subordinate, same as above, the master start to the dispatch application of the master phone 2, inputs information on the Vehicle request screen (FIG. 4). The master gets driver vehicle information from the Driver confirmed screen (FIG. 9) in the master phone 2, and also gets a password send from the management server 4. The master informs the password to the subordinate by phone call using the phone 3A. The subordinate is informed the dispatch request and the driver information from the master through the phone 3A. When the vehicle arrives to a pick-up place, the subordinate boards on the vehicle. Then the subordinate inputs the password on the driver phone 5. Then the driver sends a boarding completion notice with the password to the management server 4.

### Operating Procedure of the System of the Second Embodiment

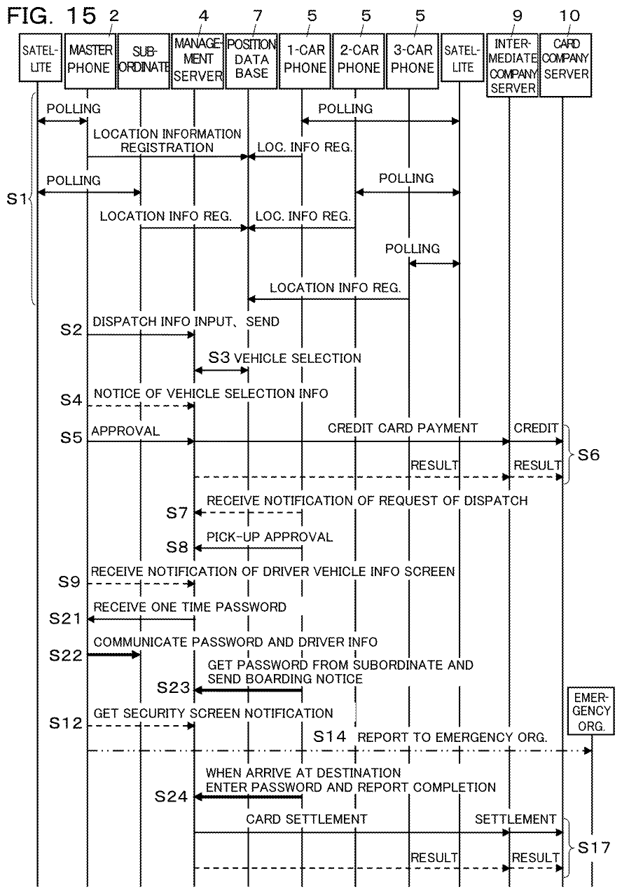

FIG. 15 is a time chart showing an operating procedure of the allocation system according to the second embodiment. In FIG. 15, processing from S1 to S9, and S6, S17 are the same with FIG. 14. After received a notice of a vehicle information screen (S9), the master phone 2 receives one-time password generated by the management server 4 (S21). The master informs the password and driver▪vehicle information to the subordinate via the phone 3A (S22). When the vehicle arrives to the pick-up place, the subordinate boards on the vehicle. The driver listens the password from the boarding subordinate, and sends a boarding notice with the password to the management server 4 by the driver phone 5 (S23). After then, the processing notice of the security screen of S12, and the report to the emergency organization of S14 are the same with the above. When arrived to the destination, the driver reports the completion inputting password by the driver phone 5 to the management server 4 (S24).

### Security Camera

Following is explanation of a security camera 8 (camera) for automotive to get an internal video according to the first and second embodiment. After receiving a notice of boarding completion from the subordinate phone 3, the management server 4 make the master phone 2 and/or the subordinate phone 3 viewable an internal video got by the camera 8. In case of the camera 8 has the Sim line, the camera 8 sends an internal video via telephone line and the internet 6 to the management server 4. The management server 4 configures the security screen viewable for the master phone 2 at a viewable time (moving image information viewable time). Instead of the above, the management server 4 only notices URL for browse the camera information or a cypher code information for connection. It is desirable to have a start button for viewing a moving image video, a column of present vehicle position information, and an emergency report button on a screen of the master phone 2 and/or the subordinate phone 3. Because of this, it can report easily in case of emergency.

The moving image information viewable time is a time during which a recorded information by the camera can be browsed, when the vehicle arrives to in the vicinity of the destination based on the GPS information of the driver phone 5. The time is a constant time (until after 5 minutes for example) since tapping the Fare send button of the driver terminal 5 or a credit card payment finish button of the subordinate phone 3 after boarding passenger arrives to the destination. Moving image video up to the time when passengers are judged to have got off may be viewable on the master phone 2. By limiting the time in this way, it will protect privacy as much as possible and reduce communication costs, security is guaranteed during times when emergency is likely to occur.

In case that the subordinate phone 3 is connectable to the internet (the first embodiment), it is preferable to make add an account and share accounts for the master and the subordinate in order to limit a viewable time. Then, it is possible to notify the management server 4 that the subordinate has got off by tapping an arrival complete button of the subordinate phone 3 when the subordinate arrives at the destination.

In case that the phone 3A which is not connectable to the internet (the second embodiment), if the vehicle is confirmed by the master phone 2, the management server 4 sends one-time password (4 digits numeral for example) by a short mail to the master phone 2 in each of a dispatch request confirmed. The password is proof of dispatch confirmed. The master tells the password to the planned boarding subordinate by using communication means such as a phone 3A (Fixed-line phone). When boarding on the vehicle, the subordinate tells the password to the driver. Then, the driver inputs the password on a boarding confirmation screen of the driver phone 5. If the input is correct, screen operation of the driver phone 5 becomes possible. If the input is inappropriate, boarding complete cannot confirm, and later operations of the driver phone 5 become impossible, and the subordinate cannot pay credits. Dispatch business will be canceled. After input properly and arrive to the destination, the driver taps a complete button of the driver phone 5 to notice the management server 4 that the subordinate got off.

### Camera Line

The line of the Camera 8 will be described below.

(1) In case of the camera 8 has a Sim (Subscriber Identity Module card) Line, the boarding subordinate owns the subordinate phone 3, and the driver always starts the camera 8:

Being tapped a boarding complete button when the subordinate boarding, the boarding complete information is noticed to the management server 4. Then the master phone 2 can receive a notice of a security screen from the management server 4 at a time of accessing thereto. The noticed security screen includes information such as a moving image, voice, and a position in the car on which the subordinate boarded. In the event of an emergency, the master can report it to the emergency organization by the master phone 2.

(2) In case of the camera 8 is stopped by the driver in the above:

When the subordinate tap the boarding complete button at a boarding by the subordinate phone 3, the boarding complete information is noticed to the management server 4. The notice include instructions to start the camera 8. Then, the camera 8 automatic access every predetermined time to the management server 4. Thereby the camera 8 starts and sends a video to the management server 4. After then, as above, when accessing from the master phone 2 to the management server 4, the master can receive a notice of the security screen. An instruction for start the camera 8 may be done from the screen when accessing to the management server 4 from the master phone 2.

(3) In case that the camera 8 has a Sim Line, boarding subordinate dose not possess the subordinate phone 3, and the driver stops or start the camera 8:

When the boarding complete button of the driver phone 5 is tapped, an information for start the camera 8 is noticed to the management server 4. Then, when automatically accessing the management server 4 from the camera 8 every predetermined period, the camera 8 starts and sends the video to the management server 4. The subsequent operation is the same as above.

The present invention is not limited to the above configuration of the embodiment, various modifications are possible. For example, it can be used not only for allocation (dispatch) systems but also for setting up for elderly people such as mail order or navigation. In the net mail order that uses application, payment can be credit complete, and it can be easily applied to a remote family to choose and present their favorite goods and travel.

### EXPLANATION OF SYMBOLS

1 allocation system

2 master phone

3 subordinate phone

3A phone

4 management server

5 driver phone

6 internet

7 position information date base

8 security camera

9 credit card payment intermediate company server

10 credit company server

1. An allocation system for dispatching a vehicle based on a request from a client, comprising:
a master phone owned by a master who are a client for receiving a dispatch service,
a subordinate phone owned by a dependent who is depend on the master,
a management server for processing the dispatch based on an application for executing the dispatch service according to the dispatch request from the client, and
a driver phone owned by a driver who move a vehicle to a pick-up place according to an instruction sent from the management server,
wherein
the master phone, the subordinate phone, the management server, and the driver phone are connectable to the internet,
the management server registers a personal account of the master, a master account capable of exercises master's authority, and a subordinate account depend on the master account, in accordance with a transmission from the master phone downloaded the application, wherein the master account and the subordinate account are registered with indexed,
the management server:
receives the dispatch request sent from the master phone to go a pick-up place for picking-up the subordinate,
choices adequate vehicle for the picking-up,
informs the vehicle selection information to the master phone,
receives a consent from the master phone,
informs the dispatch request to the driver phone, and then
receives a pick-up consent from the driver phone, further continuously
informs the vehicle information to the master phone and subordinate phone, and
receives a boarding completion notice send from the subordinate phone, after pick-up vehicle arriving to the pick-up place and the subordinate boarding on the vehicle.

2. The allocation system in accordance with claim 1, further comprising:
the vehicle equips a security camera for getting an internal video,
the management server receives a boarding completion notice sent from the subordinate phone, then after, makes the master phone and/or the subordinate phone viewable the internal video got by the security camera.

3. An allocation system for dispatching a vehicle based on a request from a client, comprising:
a master phone owned by a master who are a client for receiving a dispatch service,
a phone owned by a dependent who is depend on the master,
a management server for processing the dispatch based on an application for executing the dispatch service according to the dispatch request from the client, and
a driver phone owned by a driver who move a vehicle to a pick-up place according to an instruction sent from the management server,
wherein
the master phone, the management server, and the driver phone are connectable to the internet,
the management server registers a personal account of the master, a master account capable of exercises master's authority, and a subordinate's information, in accordance with a transmission from the master phone downloaded the application, wherein the master account and the subordinate's information are registered with indexed,
the management server sets a password for the subordinate's information,
the management server:
receives the dispatch request sent from the master phone to go a pick-up place for picking-up the subordinate,
choices adequate vehicle for the picking-up,
informs the vehicle selection information to the master phone,
receives a consent from the master phone,
informs the dispatch request to the driver phone, and then
receives a pick-up consent from the driver phone, further continuously
informs the vehicle information to the master phone, and sends the password to the master phone, and
receives a boarding completion notice and the password send from the driver phone, after pick-up vehicle arrives to the pick-up place and the subordinate boards on the vehicle, under conditions that the subordinate is informed of the dispatch request and the password by phone call from the master.

4. The allocation system in accordance with claim 3, further comprising:
the vehicle equips a security camera for getting an internal video,
the management server receives a boarding completion notice sent from the driver phone, then after, makes the master phone viewable the internal video got by the security camera.
